(19) United States
(12) Patent Application Publication
(10) Pub. No.: US 2024/0309683 A1
(43) Pub. Date: Sep. 19, 2024

(54) Fence Side Access Gate Latch

(71) Applicant: Carolyn Ann Grim, Charlestown, MA (US)

(72) Inventor: Carolyn Ann Grim, Charlestown, MA (US)

(21) Appl. No.: 18/185,224

(22) Filed: Mar. 16, 2023

(51) Int. Cl. E05C 1/04

(52) U.S. Cl. CPC E05C 1/04; E04H 17/013

(57) ABSTRACT

A side access gate latch that may be advantageously used on metal fences includes an elongate piece, a short piece, and a flange piece. In general, the short piece may be attached to proximal end of the elongate piece, and the flange piece may be attached to a distal end of the short piece. The elongate piece also defines an aperture for the placement of fixing screws that may be used to mount the gate latch to a gate post.

### BACKGROUND OF THE INVENTION

The present disclosure relates generally to a gate latch. More particularly the present disclosure relates to a side access gate latch that may be advantageously used on metal fences.

Fence apparatuses, such as wooden picket fences, metal rail fences, and chain-link fences can be used to delineate property lines and to deter or prevent unauthorized persons from entering a particular area. These fence apparatuses may be equipped with gates, which are portions of the fence attached to hinges that allow the gates to open and close. These gates may be locked so as to only allow authorized persons to enter a property through them.

Different types of locking mechanisms may be employed to allow an authorized person to lock a gate regardless of whether said authorized person is entering or exiting the property. For example, one locking mechanism utilizes a lever that latches onto a metal rod, typically attached to a gate post. The lever may be lifted from either side of the fence, thus freeing the metal rod and allowing the gate to swing open and close. Other locking mechanisms that may be employed include, but are not limited to, padlocks on a chain, mechanical and/or electronic keyless deadbolts, and single pole side latches, such as those sold under the trademark MagnaLatch®.

There are many problems associated with each of the above methods, and there is an even greater number of potential solutions to these problems. Therefore, what is needed is a fence side access gate latch having all of the further described features and advantages.

### SUMMARY OF THE INVENTION

The subject matter of this application may involve, in some cases, interrelated products, alternative solutions to a particular problem, and/or a plurality of different uses of a single system or article.

In one aspect, a gate latch is disclosed. In this aspect, the gate latch includes an elongate piece, a short piece, and a flange piece. The short piece is attached to both the elongate piece and the flange piece, and an aperture is defined on the elongate piece.

In another aspect, a fence apparatus is disclosed. In this aspect, the fence apparatus includes a gate connected to a fence, wherein the gate and the fence both include a gate post and a fence post, respectively. There is a gap between the gate post and the fence post, and a gate latch is attached to the gate post. The gate latch includes all of the elements disclosed in the previous aspect.

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF DRAWINGS

FIG. 1 provides a perspective view of one embodiment of the present disclosure.

FIG. 2 provides a perspective view of another embodiment of the present disclosure.

FIG. 3 provides a perspective view of an embodiment of a fence apparatus constructed according to the present disclosure.

FIG. 4A provides a front side perspective view of an embodiment of the present disclosure.

FIG. 4B provides a rear side perspective view of an embodiment of the present disclosure.

FIG. 5 provides a perspective view of yet another embodiment of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns a fence side access gate latch that may be advantageously used on metal fences. Specifically, the gate latch may enable a person either entering or exiting through a gate to lock the gate using only a single slide bolt lock that may be mounted on a side of a fence post. While the gate latch may be advantageously used on metal fences and gates in combination with a slide bolt lock, it should be expressly understood that other uses for the gate latch are within the scope of the present disclosure.

The gate latch disclosed herein solves several problems with other locking mechanisms. For example, non-secure gate latches that may utilize a gravity lever do not give authorized persons the option of using a security code. At best, a keyed padlock may be used in combination with such a mechanism; however, for large numbers of authorized persons, this solution is impractical. The reason for this is that only a key would unlock the keyed padlock, so multiple key copies would be necessary.

Other mechanisms may utilize a padlock with a keypad; however, these types of mechanisms are often bulky and, accordingly, incompatible with many known locking mechanisms. For chain link fences, a keypad padlock may be used to lock a chain wrapped around a gate post and a fence post; however, this option is noisy when used and is only accessible from one side of the fence.

Other mechanisms such as mechanical keyless deadbolts, electronic keyless deadbolts, and single pole side latches suffer from being bulky, only being accessible from one side of the fence, and/or being difficult to use for a multitude of reasons, respectively. The gate latch disclosed herein surprisingly solves all of these problems by providing a relatively small, visually unobtrusive option that enables use of a combination or keypad lock and can be unlocked, opened, closed, and locked from either side of a fence.

In some embodiments, the gate latch may be constructed from a metal material. Embodiments that utilize a metal gate latch may provide the critical benefit of the gate latch being weather resistant. The gate latch may be generally constructed by combining an elongate piece, at least one short piece, and at least one flange piece. The pieces may be combined by techniques know in the art, such as welding. Alternatively, the pieces may each constitute individual portions of a single piece by being integrally connected from the start. In other words, the elongate, short, and flange pieces may be integrally connected as a single piece and formed into the shape of the gate latch during manufacturing.

In some embodiments, the elongate piece, the short piece, and the flange piece may be flat, rectangular pieces that may curve into one another and/or may be connected at approximately right angles. As used herein, the term “flat” refers to a piece of material that is not thicker than 1.5″, and the term “approximately” means±10° when referring to angles. A short piece and a flange piece may not be the same length; however, in most embodiments, neither a short piece nor a flange pieces will equal or exceed the length of an elongate piece.

In one embodiment, the gate latch is generally formed as a J-shaped piece of material. As used herein, the term “J-shape” refers to the overall profile of the gate latch as formed by an elongate piece, a short piece, and a flange piece. The term “J-shape” may be used to refer to embodiments of the gate latch where the pieces curve into one another or to embodiments where the pieces are connected at approximately right angles.

In other embodiments, the gate latch may include two short pieces and two flange pieces connected at opposite ends of an elongate piece. In such an embodiment, the gate latch may be generally formed as a C-shaped piece of material. As used herein, the term “C-shape” refers to the overall profile of the gate latch as formed by an elongate piece, two short piece, and two flange pieces. The term “C-shape” may be used to refer to embodiments of the gate latch where the pieces curve into one another or to embodiments where the pieces are connected at approximately right angles.

In most embodiments, at least one aperture is defined in an elongate piece, a short piece, and/or a flange piece. The aperture(s) may be defined on the elongate piece, the short piece, and/or the flange piece attached to the gate post because the purpose of the aperture(s) is to provide a location for a screw to secure or fix the gate latch to a gate post. In one embodiment, the elongate piece defines a slot to provide multiple different locations for the placement of a screw. In another embodiment, the elongate piece and flange piece both define a circular hole for the placement of two fixing screws on both the front and rear side of a gate post. As used herein, the term “aperture” may be used to refer to all different types of opening formed in the gate latch, including, but not limited to, slots and circular holes.

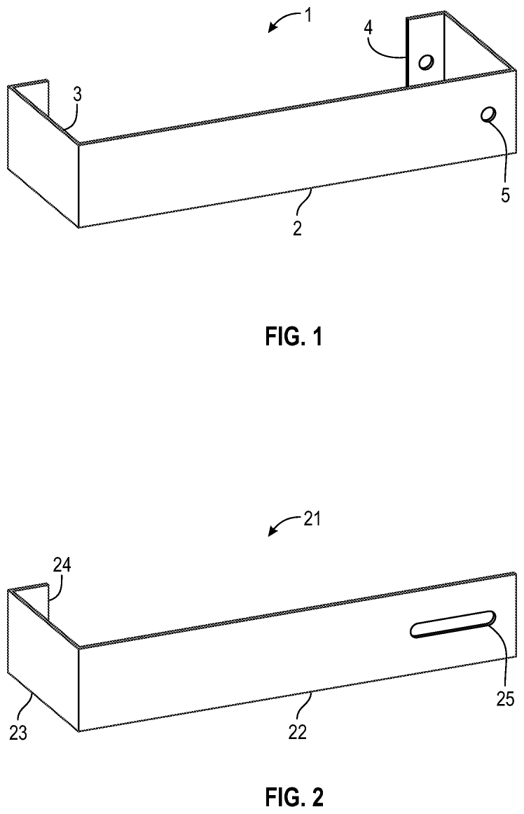

Turning now to FIG. 1, one embodiment of the gate latch 1 is shown. In this embodiment, the gate latch 1 is C-shaped and formed by an elongate piece 2 connected to two short pieces 3. Proximal ends of each one of the short pieces 3 are connected to opposite ends of the elongate piece 2. The short pieces 3 intersect with the elongate piece 2 at approximately right angles. The C-shaped gate latch 1 also includes two flange pieces 4 connected to distal ends of each one of the short pieces 3. Similar to the connection between the short pieces 3 and the elongate piece 2, the two flange pieces 4 also intersect with the short pieces 3 at approximately right angles. One of the flange pieces 4 attached to one of the short pieces 3 defines a circular hole 5. Similarly, the elongate piece defines a circular hole 5 proximate to the short piece 3 attached to the flange piece 4 that also defines a circular hole 5. Particularly, in this embodiment, the two circular holes 5 are aligned in substantially the same axis. As used herein, the terminology “substantially the same axis” refers to an axis that intersects with a surface at approximately a right angle; however, the orientation of the axis may deviate by up to and including 45° from the approximate right angle orientation.

FIG. 2 shows another embodiment of a gate latch 21. In this embodiment, the gate latch 21 is J-shaped and formed by an elongate piece 22 connected to a short piece 23. A proximal end of the short piece 23 is connected to a proximal end of the elongate piece 22, and both the short piece 23 and the elongate piece 22 intersect at approximately right angles. The J-shaped gate latch 21 includes a flange piece 24 connected to a distal end of the short piece 23, and the flange piece 24 intersects with the short piece 23 at approximately a right angle. The elongate piece 22 also defines a slot 25 proximate to a distal end of the elongate piece 22.

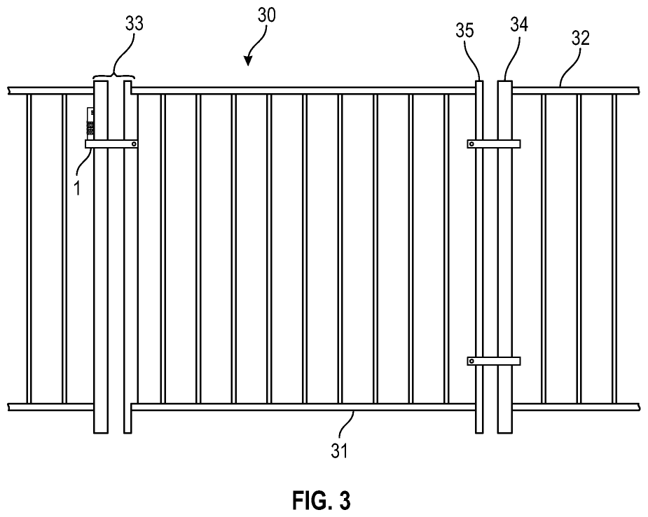

FIG. 3 shows an embodiment of a fence apparatus 30 incorporating an embodiment of a gate latch 1, a gate 31, and a fence 32. In this embodiment, the gate latch 1 spans the gap 33 defined between the fence post 34 and the gate post 35. The purpose of the gate latch 1 in this embodiment is to allow a person either entering or exiting through the gate 31 to lock the gate 31 using only a single lock that is mounted on the side of the fence post 34. One of the primary apparent benefits of the fence apparatus 30 is the visually unobtrusive combination of a relatively small lock and gate latch 1 that is easily accessible from either side of the gate 31 or fence 32.

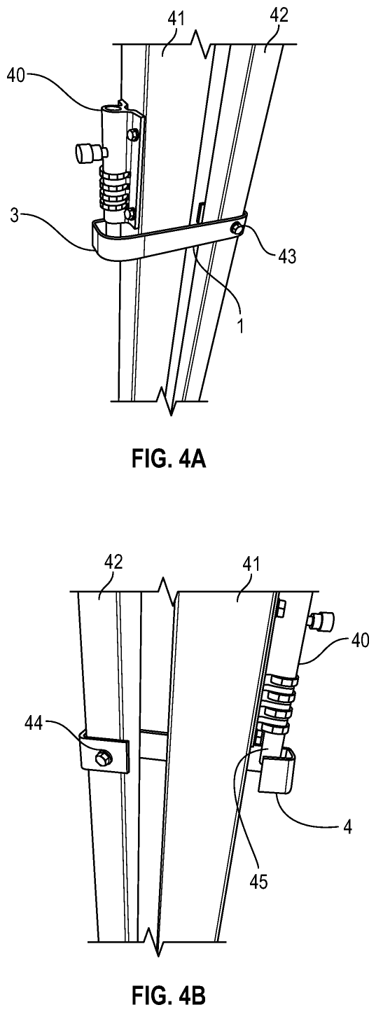

Turning now to FIGS. 4A and 4B, which shows another embodiment of a slide bolt lock 40 attached to a fence post 41 and a C-shaped gate latch 1 attached to a gate post 42. The gate latch 1 is secured to the gate post 42 by at least one screw 43. In this embodiment, the short pieces 3 curve around the fence post 41 and the gate post 42, respectively. The curved C-shape embodiment of the gate latch 1 may provide a more secure connection when compared with other embodiments because one of the short pieces 3 curves around the back of the gate post 42 and is secured by a second screw 44. The bolt 45 protruding from the slide bolt lock 40 prevents the gate from opening by blocking the flange piece 4 attached to the second short piece 3.

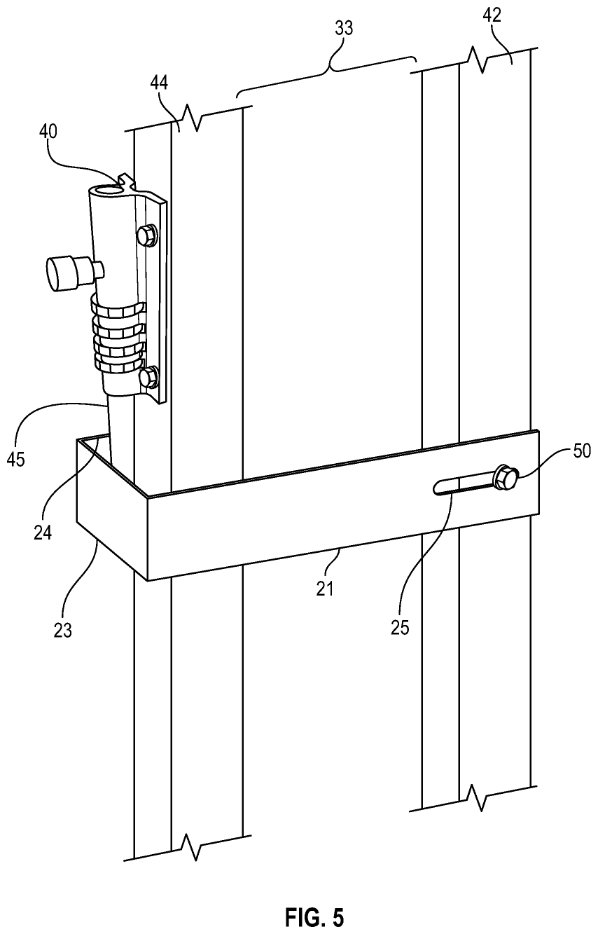

Similarly, as shown in FIG. 5, a J-shaped gate latch 21 is also in a locked configuration because the bolt 45 is protruding from the slide bolt lock 40. The bolt 45 prevents the gate from opening by blocking the path of the flange piece 24, which is attached to the short piece 23 at a proximal end of the gate latch 21. A distal end of the gate latch 21 defines a slot 25. The slot 25 allows the gate latch 21 to adjust to differently sized gaps 33 between the gate post 42 and the fence post 41. The reason for this is that there are multiple different locations within the slot 25 where the screw 50 can be placed in order to fix the gate latch 21 to the gate post 42.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A gate latch comprising:
an elongate piece attached to a short piece;
a flange piece attached to the short piece; and
an aperture defined on the elongate piece.

2. The gate latch of claim 1 further comprising a second short piece attached to the elongate piece.

3. The gate latch of claim 1 wherein the short piece is connected to a proximal end of the elongate piece.

4. The gate latch of claim 1 wherein the short piece intersects with the elongate piece at approximately a right angle.

5. The gate latch of claim 1 wherein the elongate piece curves into the short piece.

6. The gate latch of claim 1 wherein the elongate piece comprises a metal material.

7. The gate latch of claim 1 wherein the elongate piece is rectangular.

8. The gate latch of claim 1 wherein the elongate piece is flat.

9. The gate latch of claim 1 wherein the aperture is a circular hole.

10. The gate latch of claim 1 wherein the aperture is a slot.

11. A fence apparatus comprising:
a gate connected to a fence;
the gate comprising a gate post, and the fence comprising a fence post;
a gap defined between the gate post and fence post;
a gate latch attached to the gate post, the gate latch comprising:
an elongate piece attached to a short piece;
a flange piece attached to the short piece; and
an aperture defined on the elongate piece.

12. The fence apparatus of claim 11 further comprising a lock attached to the fence post.

13. The fence apparatus of claim 12 wherein the lock is a slide bolt lock.

14. The fence apparatus of claim 11 wherein the gate latch is secured to the gate post by a screw.

15. The fence apparatus of claim 11 wherein the gate latch is J-shaped.

16. The fence apparatus of claim 11 wherein the gate latch further comprises a second short piece and a second flange piece attached to the second short piece.

17. The fence apparatus of claim 16 wherein the elongate piece, the short piece and the flange piece, and the second short piece and the second flange piece define a C-shape.

18. The fence apparatus of claim 17 wherein the gate latch is secured to the gate post by two fixing screws, one of the two fixing screws extending through a hole defined in the elongate piece and a second one of the two fixing screws extending through a second hole defined in the second flange piece.

19. The fence apparatus of claim 11 wherein the gate comprises a metal material and the fence comprises a metal material.

20. The fence apparatus of claim 11 wherein the elongate piece of the gate latch spans the gap defined between the gate post and the fence post.
